(19) United States
(12) Patent Application Publication
(10) Pub. No.: US 2020/0190442 A1
(43) Pub. Date: Jun. 18, 2020

(54) METHOD FOR TREATING FABRICS WITH A VARYING PH PROFILE DURING WASH AND RINSE CYCLES

(71) Applicant: The Procter & Gamble Company, Cincinnati, OH (US)

(72) Inventors: Anju Deepali Massey BROOKER, Newcastle Upon Tyne (GB); Carlos AMADOR ZAMARRENO, Newcastle Upon Tyne (GB); Laura BUENO ROMO, Newcastle Upon Tyne (GB); Katherine Esther LATIMER, Newcastle Upon Tyne (GB); Libbi MOON, Newcastle Upon Tyne (GB); Evangelia ARGENTOU, Newcastle Upon Tyne (GB)

(21) Appl. No.: 16/690,275

(22) Filed: Nov. 21, 2019

(30) Foreign Application Priority Data
Dec. 13, 2018 (EP) 18212138.4

(51) Int. Cl. C11D 11/00; C11D 1/83; C11D 3/00; C11D 3/37; C11D 3/24

(52) U.S. Cl. CPC C11D 11/0017; C11D 1/83; C11D 1/146; C11D 3/3715; C11D 3/24; C11D 3/0036

(57) ABSTRACT

The present invention relates to a method for treating fabrics by contacting the fabrics with an aqueous wash liquor at varying pH values that increase from about 7-9 to about 10-13 (optionally down to about 7-9), maintaining such contact at pH 10-13 for about 5-30 minutes, followed by contacting the fabrics with an aqueous rinse liquor at an acid pH value of about 4-6. Such method provides a significantly improved stain removal benefit without any formulation changes. Further, it enables the use of laundry detergent compositions that are essentially free of alkoxylated surfactants, such as alkylalkoxylated sulfates or alkylalkoxylated alcohols, while still delivering satisfactory stain removal results.

### FIELD OF THE INVENTION

This invention is related to an improved method for treating fabrics, particularly in an automatic washing machine with programmed wash and rinse cycles, by providing a varying pH profile with different, specific pH values at specific time periods during respective wash and rinse cycles. The method of the present invention is particularly beneficial for cleaning body soils from fabric.

### BACKGROUND OF THE INVENTION

Automatic washing machines for laundering fabrics typically operate with at least four cycles, including at least one wash cycle in which the fabrics to be treated are contacted with an aqueous wash liquor (which contains water with cleaning actives such as surfactants, detersive builders, enzymes, bleach, polymers, etc.) in a washing drum, at least a first spin cycle for removing at least a significant portion of the wash liquor from the washing drum, at least one rinse cycle in which the fabrics are contacted with an aqueous rinse liquor (which may contain only water, or water with fabric care actives such as softeners, surface modifiers, anti-wrinkle agents, perfumes, etc.) in the washing drum, and at least a second spin cycle for removing all or most of the rinse liquor from the washing drum. In some cases, there may be more than one wash cycle, more than one rinse cycle, and/or more than two spin cycles.

The aqueous wash liquor is typically characterized by a relatively high pH value, e.g., at least above 7 and more commonly above 9. The aqueous rinse liquor is typically characterized by a pH value that is lower than that of the aqueous wash liquor, e.g., from 6.5 to 9. With added fabric care actives, the aqueous rinse liquor may turn slightly acidic, and its pH value may fall below 7 at times, but not significantly lower.

U.S. Pat. No. 4,828,750 discloses a fabric rinse formulation consisting of low levels of a nonionic surfactant, low levels of an organic acid such as citric acid and/or sodium citrate, and a major amount of water. Such a fabric rinse formulation has an adjusted pH value of about 4.5-6.5, and it is particularly effective in removing soap and surfactant residues retained on the fabric after wash.

WO2005/061685 discloses a method of laundering fabrics in an automatic washing machine by using an aqueous wash liquor with a pH above 7 (preferably 7.5-10, more preferably 7.5-9, most preferably about 8.5) during the wash cycle, followed by adding sufficient acid source to an aqueous rinse liquor to bring the pH of the rinse liquor down to about 4-7 (preferably 4.5-6.5, more preferably about 5.5). The use of such a low pH rinse liquor has been found to bring a wide variety of benefits, such as improving decolorization of bleachable stains, and/or promoting grease removal, and/or promoting cleaning of complex soils (i.e., built up combinations of body soil, detergent, softener and/or hard water residues), and/or reducing dye transfer, and/or reducing residue build-up on fabrics.

There is a continuing need for improved methods for treating fabrics, especially in an automatic washing machine with programmed wash and rinse cycles, to achieve better cleaning results, and especially for cleaning body soils from fabric. Such achievement is preferably accomplished without significantly increasing manufacturing costs associated with the wash/rinse additives or operating costs/energy consumption associated with the automatic washing machine.

### SUMMARY OF THE INVENTION

The present invention provides an improved method for treating fabrics, by contacting the fabrics to be treated with an aqueous wash liquor at varying pH values that increase from a first pH value of about 7-9 to a second, higher pH value of about 10-13 (optionally then down to about 7-9) during a wash cycle, maintain contact between such fabrics and the aqueous wash liquor at the second, higher pH value for about 5-30 minutes, followed by contacting the fabrics with an aqueous rinse liquor at a third, acidic pH value of about 4-6 during a rinse cycle. Such method provides a significantly improved stain removal benefit without significant formulation changes and without increasing the energy consumption or operating costs. Further, it enables the use of laundry detergent compositions that are essentially free of alkoxylated surfactants, such as alkylalkoxylated sulfates or alkylalkoxylated alcohols, while still delivering satisfactory stain removal results.

In one aspect, the present invention relates to a method of treating fabrics, comprising the steps of:
a) Contacting fabrics with an aqueous wash liquor containing at least one detersive surfactant, wherein said aqueous wash liquor is characterized by a first pH ranging from about 7.0 to about 9.0;
b) Increasing the pH of said aqueous wash liquor to a second pH ranging from about 10.0 to about 13.0, while allowing the fabrics to continue contacting with such aqueous wash liquor for a duration ranging from about 5 minutes to about 30 minutes; and
c) Contacting the fabrics with an aqueous rinse liquor that is characterized by a third pH ranging from about 3.0 to about 6.0.

Preferably, the aqueous wash liquor used in the method of the present invention is essentially free of C₁₀-C₂₀ linear or branched alkylalkoxylated sulfates (AAS) and C₁₀-C₂₀ linear or branched alkylalkoxylated alcohols (AA). More preferably, such aqueous wash liquor is essentially free of any alkylalkoxylated surfactants. Such aqueous wash liquor may comprise one or more C₁₀-C₂₀ linear alkyl benzene sulphonates (LAS) or alkyl sulfates (AS) as the main surfactant(s).

These and other aspects of the present invention will become more apparent upon reading the following detailed description of the invention.

### BRIEF DESCRIPTION OF DRAWINGS

FIG. 1 is a schematic diagram of a stain before and after wash.

### DETAILED DESCRIPTION OF THE INVENTION

Inventors of the present invention have discovered that by using a varying pH profile with specific, different pH values at specific time periods during wash and rinse cycles can effectively improve the overall stain removal benefit, with little or no formulation changes and with little or no increase to the energy consumption or operating cost of the automatic washing machine (if one is used).

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the terms “essentially free of” or “essentially from” mean that the indicated material is at the very minimum not deliberately added to the composition to form part of it, or, preferably, is not present at analytically detectable levels. It is meant to include compositions whereby the indicated material is present only as an impurity in one of the other materials deliberately included.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

Fabric Laundering Method with Varying pH Profiles

The method of the present invention can be carried out by any means, e.g., manual wash, semi-automatic machine wash, or automatic machine wash. Preferably but not necessarily, it is carried out by using an automatic washing machine with pre-programmed wash, spin, and rinse cycles, as described hereinafter.

The automatic washing machine that can be optionally used for practice of the present invention may comprise a drum in which the fabrics are placed for laundering. The aqueous wash liquor and the aqueous rinse liquor can be added into such drum, or they can be formed in situ therein.

The automatic washing machine is preferably pre-programmed with at least one wash cycle, at least a first spin cycle, at least one rinse cycle, and at least a second spin cycle. In some cases, there may be more than one wash cycle and/or more than one rinse cycle, each of which is followed by a spin cycle to remove the wash/rinse liquor used in the respective wash/rinse cycle.

Multiple wash cycles are often described as one or more pre-wash cycles and a main wash cycle. In the discussion below, the aqueous wash liquor is typically used in the main wash cycle, and particularly in the last wash cycle before the rinse cycle. The main wash cycle typically lasts for a duration ranging from about 10 minutes to about 150 minutes, preferably from about 15 minutes to about 120 minutes, more preferably from about 20 minutes to about 60 minutes.

Steps (a) and (b) as described hereinabove are preferably carried out during the main wash cycle. Alternatively, it is possible to carry out step (a) in a pre-wash cycle, followed by a spin cycle, and subsequently step (b) is carried out in the main wash cycle.

Specifically, in step (a), the fabrics to be treated are first contacted with an aqueous wash liquor containing at least one detersive surfactant, preferably in the drum of an automatic washing machine (but can also be in a wash basin or bucket used for handwashing of the fabrics). The aqueous wash liquor used in step (a) is characterized by a first pH ranging from about 7.0 to about 9.0, preferably from about 7.5 to about 8.5, more preferably about 8.0. During step (a), the fabrics are contacted with such aqueous wash liquor of the first pH value for a duration ranging from about 1 minute to about 30 minutes, preferably from about 1 minutes to about 10 minutes, or even from 1 minute to 5 minutes.

Typically, the aqueous wash liquor is formed prior to contact with the fabric. Typically, the detersive surfactant and other cleaning actives, if present, are contacted to water to form the aqueous wash liquor. The aqueous wash liquor is then typically contacted to the fabric.

Next in step (b), the pH of said aqueous wash liquor is increased to a second, higher value of from about 10.0 to 13.0, preferably from about 10.5 to about 12.5, more preferably from about 11.0 to about 12.0. Such pH increase can be readily achieved by adding one or more alkaline agents (e.g., sodium hydroxide, potassium hydroxide, sodium carbonate, potassium carbonate, sodium bicarbonate, potassium bicarbonate, etc.) into said aqueous wash liquor, or by adding into said existing aqueous wash liquor a new aqueous wash liquor of a higher pH value (the mixture thereof then has a pH value that fits into the desired pH range), or by draining the existing aqueous wash liquor and replacing it with a fresh batch of aqueous wash liquor of a higher pH value that is within the desired pH range.

During step (b), the fabrics are contacted with the aqueous wash liquor of the second, higher pH value for a duration ranging from about 5 minutes to about 30 minutes, preferably from about 8 minutes to about 25 minutes, more preferably from about 10 to about 20 minutes.

It has been discovered by the present invention that if step (b) is missing (i.e., there is little or no pH increase during the wash cycle), or if steps (a) and (b) are reversed (i.e., the wash cycle starts with the higher pH value and then decreases to the lower pH value), or if step (b) lasts for too long (i.e., the fabrics are exposed to the higher pH for longer than about 30 minutes), the stain removal results may be adversely affected. The sequence of steps (a) and (b) and their respective pH values as well as the duration of step (b) are all important to ensure optimal stain removal results.

Further, the wash cycle comprises an additional step (b1), which occurs after step (b) but before step (c), i.e., before the rinse cycle starts, in which the pH of the aqueous wash liquor is decrease, e.g., back to a lower pH value ranging from about 7.0 to about 9.0, preferably from about 7.5 to about 8.5, more preferably about 8.0. In such step (b1), the fabrics may be contacted with the aqueous wash liquor of the lower pH value for a duration ranging from about 1 minute to about 60 minutes, preferably from about 2 minutes to about 50 minutes, more preferably from about 5 minutes to about 40 minutes. Step (b 1) is not critical but only optional for the practice of the present invention.

After step (b1), the aqueous wash liquor is preferably drained or otherwise removed, e.g., by one or more spin cycle, during which the drum of the automatic washing machine is caused to spin, generally at high speed. During the spin cycle, a large portion of the aqueous wash liquor in the drum, preferably from about 50% to about 99%, more preferably from about 60% to about 90%, is removed.

Subsequently, the rinse cycle starts, in which the already washed fabrics are contacted with an aqueous rinse liquor that is characterized by a third pH ranging from about 3.0 to about 6.0, or from 3.0 to 5.6, or from 3.0 to 5.0, or preferably from about 3.5 to about 4.5, more preferably about 4.0, as described hereinabove for step (c). When the rinse cycle includes multiple rinses, at least one of the rinses is step (c) and has the required pH profile of step (c). It maybe preferred that the rinse cycle has two rinses, and the last rinse is step (c). It may also be preferred that the rinse cycle has three rinses, and the second to last rinse is step (c). Preferably in step (c), the fabrics are contacted with the aqueous rinse liquor for a duration ranging from about 1 minute to about 30 minutes, preferably from about 5 minutes to about 20 minutes, more preferably from about 10 minutes to about 15 minutes.

It has been discovered by the present invention that if the aqueous rinse liquor used in step (c) has a pH value that is significantly higher than the desired range of about 3-5 (e.g., 6.5 or above), little or no improvement is observed in the stain removal results.

The increased pH value of the aqueous was liquor used during step (b) can be achieved by adding one or more base source into such wash liquor. Any suitable basic material or base precursor compatible with the fabrics to be treated can be used herein. Exemplary base source include, but are not limited to: (a) inorganic bases, such as NaOH (i.e., caustic), KOH, and the like; and (b) organic bases, such as monoethanolamine (MEA).

The reduced pH value of the aqueous rinse liquor used during step (c) and/or of the aqueous wash liquor used during step (b1) can be achieved by adding one or more acid source into such rinse liquor. Any suitable acidic material or acid precursor compatible with the fabrics to be treated can be used herein as the acid source. Exemplary acid sources include, but not limited to: (a) inorganic acids; (b) organic acids, which are preferred and include maleic acid, citric acid, oxalic acid, acetic acid, and the like; (c) polymeric acids, such as polyacrylic acid, polymaleic acid, acrylic acid/maleic acid copolymers. Particularly preferred are mono or polyprotic organic acids, with citric acid being the most preferred.

The above-mentioned base and/or acid sources can be added into the incoming water pipeline of the automatic washing machine based on the amount of total water determined by a flow meter and a given base/acid-to-water ratio, so as to achieve the desired pH during the wash and/or rinse cycles. The base and/or acid sources can also be added directly through the detergent container built in the automatic washing machine during the wash and/or rinse cycles, while preferably the automatic washing machine also contains a pH sensor for monitoring and controlling the pH value of the wash and/or rinse liquor. Further, the automatic washing machine may be equipped with a pH meter or sensor that is in wireless communication with a base/acid dosing device to automatically control/adjust the pH profile of the wash and/or rinse liquor in real time. Typically, it may be preferred that active ingredients, such as perfume and/or fabric softening agents are dosed into the aqueous rinse solution during the last rinse of the rinse cycle. Other active ingredients, such as hueing dye and/or brightener, can also be dosed into the aqueous rinse solution during the last rinse of the rinse cycle.

### Aqueous Wash Liquor

The aqueous wash liquor used in steps (a), (b) and optionally (b 1) of the inventive method of the present invention may contain one or more detersive surfactants, including but not limited to: anionic surfactants, nonionic surfactants, cationic surfactants, zwitterionic surfactants, amphoteric surfactants, and combinations thereof.

Preferably, the aqueous wash liquor of the present invention includes an anionic surfactant in combination with a nonionic surfactant.

Useful anionic surfactants can themselves be of several different types. For example, water-soluble salts of the higher fatty acids, i.e., “soaps”, are useful anionic surfactants in the aqueous wash liquor herein. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. Additional non-soap anionic surfactants which are suitable for use herein include the water-soluble salts, preferably the alkali metal, and ammonium salts, of organic sulfuric reaction products having in their molecular structure an alkyl group (included in the term “alkyl” is the alkyl portion of acyl groups) containing from about 10 to about 20 carbon atoms and a sulfonic acid or sulfuric acid ester group. Examples of this group of synthetic anionic surfactants include, but are not limited to: a) the sodium, potassium and ammonium alkyl sulfates with either linear or branched carbon chains, especially those obtained by sulfating the higher alcohols (C₁₀-C₂₀ carbon atoms), such as those produced by reducing the glycerides of tallow or coconut oil; b) the sodium, potassium and ammonium alkylethoxy sulfates with either linear or branched carbon chains, particularly those in which the alkyl group contains from about 10 to about 20, preferably from about 12 to about 18 carbon atoms, and wherein the ethoxylated chain has, in average, a degree of ethoxylation ranging from about 0.1 to about 5, preferably from about 0.3 to about 4, and more preferably from about 0.5 to about 3; c) the sodium and potassium alkyl benzene sulfonates in which the alkyl group contains from about 10 to about 20 carbon atoms in either a linear or a branched carbon chain configuration, preferably a linear carbon chain configuration; d) the sodium, potassium and ammonium alkyl sulphonates in which the alkyl group contains from about 10 to about 20 carbon atoms in either a linear or a branched configuration; e) the sodium, potassium and ammonium alkyl phosphates or phosphonates in which the alkyl group contains from about 10 to about 20 carbon atoms in either a linear or a branched configuration; and f) the sodium, potassium and ammonium alkyl carboxylates in which the alkyl group contains from about 10 to about 20 carbon atoms in either a linear or a branched configuration, and combinations thereof. Especially preferred for the practice of the present invention are surfactant systems containing C₁₀-C₂₀ linear alkyl benzene sulphonates (LAS) and C₁₀-C₂₀ linear or branched unalkoxylated alkyl sulfates (AS).

Preferred for the practice of the present invention are aqueous wash liquors that contain one or more LAS surfactants, as described hereinabove. The LAS can be present in said aqueous wash liquor at an amount ranging from about 100 ppm to about 2000 ppm, preferably from about 200 ppm to about 1500 ppm, more preferably from about 300 ppm to about 1000 ppm.

The aqueous wash liquor may comprise (either as an alternative to LAS or in combination with LAS) one or more AS surfactants, as described hereinabove. The AS surfactant(s) can be present in the aqueous wash liquor at an amount ranging from about 100 ppm to about 2000 ppm, preferably from about 200 ppm to about 1500 ppm, more preferably from about 300 ppm to about 1000 ppm.

The aqueous wash liquor may further comprise one or more C₁₀-C₂₀ linear or branched alkylalkoxylated sulfates (AAS) having an average degree of ethoxylation ranging from about 0.1 to about 5, preferably from about 0.3 to about 4 and more preferably from about 0.5 to about 3. Such AES surfactants can be present therein at an amount ranging from about 0 ppm to about 1000 ppm, preferably from about 0 ppm to about 500 ppm, more preferably from about 0 ppm to about 300 ppm.

Further, the aqueous wash liquor may contain from about 0 ppm to about 1000 ppm, preferably from about 0 ppm to about 500 ppm, more preferably from about 0 ppm to about 200 ppm, of a nonionic surfactant. Preferred nonionic surfactants are those of the formula R¹(OC₂H₄)ₙOH, wherein R¹ is a C₁₀-C₂₀ alkyl group or alkyl phenyl group, and n is from about 1 to about 80. Particularly preferred are C₁₀-C₂₀ alkylalkoxylated alcohols (AA) having an average degree of alkoxylation from 1 to 20.

Preferably, the aqueous wash liquor may comprise LAS and/or AS as the main surfactant(s), i.e., being present at an amount that is more than 50 wt % of the total surfactant content in said wash liquor. The LAS and/or AS surfactants are particularly suitable for use in the fabric treatment method of the present invention with a varying pH profile. Without being bound by any theory, it is believed that the combined use of LAS and/or AS surfactants with the varying pH profile during wash and rinse cycles can achieve significantly better-than-additive stain removal benefit than that achieved by using LAS and/or AS surfactants alone or by using the varying pH profile alone.

In a particularly preferred embodiment of the present invention, the aqueous wash liquor is essentially free of the AAS and the AA surfactants. More preferably, said aqueous wash liquor is essentially free of any alkylalkoxylated surfactants, and most preferably said aqueous wash liquor consists essentially of the LAS and/or AS surfactants, which are more cost-effective than the AAS and AA surfactants. It has been a surprising and unexpected discovery of the present invention that implementation of the fabric treatment method of the present invention enables the use of aqueous wash liquors that are essentially free of AAS and AA surfactants (preferably essentially free of any alkylalkoxylated surfactants), while still maintaining at least comparable stain removal benefits or achieving even better stain removal results.

Other surfactants useful herein include amphoteric surfactants and cationic surfactants. Such surfactants are well known for use in laundry detergents and are typically present at levels from about 10 ppm to about 300 ppm, preferably from about 15 ppm to about 200 ppm, more preferably from about 20 ppm to about 100 ppm.

The aqueous wash liquor of the invention may also contain one or more adjunct ingredients commonly used for formulating liquid laundry detergent compositions, such as builders, fillers, carriers, structurants or thickeners, clay soil removal/anti-redeposition agents, polymeric soil release agents, polymeric dispersing agents, polymeric grease cleaning agents, enzymes, enzyme stabilizing systems, amines, bleaching compounds, bleaching agents, bleach activators, bleach catalysts, brighteners, dyes, hueing agents, dye transfer inhibiting agents, chelating agents, softeners or conditioners (such as cationic polymers or silicones), perfumes (including perfume encapsulates), hygiene and malodor treatment agents, and the like. Preferably, the aqueous wash liquor of the present invention is substantially free of any fabric softening agent.

In a preferred embodiment of the present invention, the aqueous wash liquor of the present invention comprises an anionic soil release polymer, preferably a terephthalate polymer, more preferably an anionic polyester of propylene terephthalate, such as that commercially available from Clariant under the tradename TexCare® SRA-300. Such anionic soil release polymer can be present in the aqueous wash liquor in an amount ranging from about 10 ppm to about 100 ppm, preferably from about 15 ppm to about 70 ppm, more preferably from about 20 ppm to about 50 ppm. It has been discovered by the present invention that such anionic soil release polymer is effective in improving the fabric whiteness benefit of the method of the present invention.

### Aqueous Rinse Liquor

The aqueous rinse liquor of the present invention may consist essentially of water, either deionized water or tap water, without any fabric care agents. Alternatively, it may comprise one or more fabric care agents selected from the group consisting of fabric softening agents, surface modifiers, anti-wrinkle agents, perfumes, and the like.

For example, the aqueous rinse liquor of the present invention may comprise a fabric softening agent at an amount ranging from about lOppm to about 2000 ppm, preferably from about 20 ppm to about 1500 ppm, more preferably from about 50 ppm to about 1000 ppm.

Preferably, the fabric softening agent is a cationic compound, such as quaternary ammonium compounds, a cationic silicone, cationic starch, smectite clay, and combinations or derivatives thereof. More preferably, it is a diester quaternary ammonium compound of formula (I):

{R₄₋ₘ—N+—[(CH₂)ₙ—Y−R⁵]ₘ}A— (I)

wherein each R is independently selected from the group consisting of hydrogen, a short chain C₁-C₆, poly(C₂-C3 alkoxy), benzyl, and mixtures thereof; m is 2 or 3; each n is independently from 1 to 4; each Y is independently —O—(O)C— or —C(O)—O—; the sum of carbons in each R⁵ is C₁₁-C₂₁, with each R⁵ independently being a hydrocarbyl or substituted hydrocarbyl group; and A— is a softener-compatible anion.

Preferably, in formula (I), each R is independently selected from a C₁-C₃ alkyl; m is 2; each n is independently from 1 to 2; each is independently —O—(O)C— or —C(O)—O—; the sum of carbons in each R⁵ is C₁₂-C₂₀, with each R⁵ independently being a hydrocarbyl or substituted hydrocarbyl group; and A— is selected from chloride, bromide, methylsulfate, ethylsulfate, sulfate, or nitrate. More preferably, the fabric softening agent is a bis-(2-hydroxyethyl)-dimethylammonium chloride fatty acid ester, preferably having an average chain length of the fatty acid moieties of from 16 to 20 carbon atoms, preferably from 16 to 18 carbon atoms.

Alternatively, the fabric softening agent can be a cationic silicone, such as polydimethylsiloxane polymers comprising at least one quaternized nitrogen atom.

The aqueous rinse liquor herein may comprise other materials, non-limiting examples of which include surfactants, solvents, salts (e.g., CaCl₂), acids (e.g., HCl and formic acid), preservatives, and water. Preferably, the aqueous rinse liquor of the present invention is substantially free of the anionic and nonionic surfactants described hereinabove for the aqueous wash liquor, and more preferably it is substantially free of any surfactants.

It may be preferred that during step (c) 5-chloro-2-(4-chlorophenoxy) phenol is dosed into the aqueous rinse liquor. Preferably a combination of 5-chloro-2-(4-chlorophenoxy) phenol and amine oxide is dosed into the aqueous rinse liquor. Preferably 5-chloro-2-(4-chlorophenoxy) phenol is dosed into the aqueous rinse liquor wherein the aqueous rinse liquor has a pH in the range of from 3.0 to 6.0, or from 3.0 to 5.6, or from 3.0. to 5.0. If present, typically the 5-chloro-2-(4-chlorophenoxy) phenol is dosed into the aqueous rinse liquor the 5-chloro-2-(4-chlorophenoxy) phenol is dosed into the aqueous rinse liquor to a concentration of from 0.1 ppm to 2.0 ppm, or preferably from 0.1 ppm to 1.0 ppm. If present, typically the amine oxide is dosed into the aqueous rinse liquor to a concentration of from 10 ppm to 400 ppm, or preferably from 50 ppm to 200 ppm.

### EXAMPLES

### Example 1

### Different pH Profiles Lead to Different Stain Removal Results

All experiments are conducted in a mid-scale high throughput equipment that runs on a Peerless Systems platform. It consists of 10 vessels of 1 L capacity with a three-blade post agitator similar to the one used by Ganguli and Eenderbug (1980), which operate in parallel. The equipment is automatized so that filling, washing, draining and rinsing of the vessels is automatically conducted by the system.

Initially cleaning of the vessels is conducted prior to start the wash process by adding 0.25 L of city water at the target washing temperature (30° C.) to each of the vessels of the equipment. The water remained in the vessels for 2 mins under a constant agitation of 1800°/s. After draining the water used for the cleaning stage, 0.8 L of city water at the target washing temperature (30° C.) is added to each of the vessels. Next, the ballast comprising 50 g of knitted cotton swatches (5 cm×5 cm) and the test items containing the stains to be analyzed (10 g of 7 cm×7 cm knitted cotton swatches) are manually added to each of the vessels where they remain in contact with the water under a constant agitation of 1800°/s for 2 min. At this moment, 0.2 L of water containing the pre-dissolved liquid detergent formulation (see Table 1) is manually added to each of the vessels and mixed for 2 additional minutes at 1800°/s prior to start the wash process.

TABLE 1

| | | Concentration |
|---|---|---|
| Component | | in the wash |
| Type | Ingredients | liquor (ppm) |
| Surfactants | Sodium lauryl sulphate | 284.18 |
| | Sodium dodecylbenzenesulfonate | 367.94 |
| | C14-15 Pareth-7 | 188.03 |
| | (Neodol 45-7) | |
| | Lauramine oxide | 28.60 |
| Builders/ | Fatty acids (palm kernel) | 86.30 |
| Chelants | Citric acid | 108.62 |
| | Hydroxyethylidene diphosphonic | 25.00 |
| | acid (HEDP) | |
| | Diethylene triamine penta(methyl | 25.00 |
| | phosphonic) acid (DTPMP) | |
| Performance | Polymer Lutensit Z96 (70%) | 29.74 |
| actives/ | Copolymer of polyethylene glycol | 43.88 |
| stabilizers | (PEG) and polyvinyl acetate (PvAc) | |

Next, in the wash process of Sequence 1, the main wash is conducted at a constant pH=8 for 30 minutes at 30° C. under a constant agitation of 1800°/s, followed by a 15-minute 30° C. rinse cycle at pH=8.

In other wash processes (Seq. 2-Seq. 7), the main wash is conducted for 30 minutes at 30° C. and a constant agitation of 1800°/s at respective pH profiles described below, followed by a 15-minute 30° C. rinse at pH=4.
Sequence 2: Comparative Example of 30-minute wash cycle at a constant pH=8, followed by an acidic rinse cycle at pH=4 for 15 minutes;
Sequence 3: Comparative Example with a 30-minute wash cycle staring with an initial pH=12 from time T=0 min to T=10 min, and then to a reduced pH=8 from T=10 min to T=30 min, followed by an acidic rinse cycle at pH=4 for 15 minutes;
Sequence 4: Comparative Example with a 30-minute wash cycle staring with an initial pH=8 from time T=0 min to T=20 min, and then to an increased pH=11 from T=20 min to T=30 min, followed by an acidic rinse cycle at pH=4 for 15 minutes;
Sequence 5: Comparative Example with a 30-minute wash cycle staring with an initial pH=8 from time T=0 to T=10, then to an increased pH=12 from T=10 to T=30, followed by an acidic rinse at pH=4 for 15 minutes. Note in this sequence, the main wash pH is held at about 12 for 20 minutes;
Sequence 6: Comparative Example with a 30-minute wash cycle staring with an initial pH=8 from time T=0 to T=20, then to an increased pH=12 from T=20 to T=30, followed by an acidic rinse at pH=4. Unexpected cleaning advantage is observed when the main wash pH is held at 12 for 10 minutes (in comparison with 20 minutes in Sequence 5);
Sequence 7: Preferred Inventive sequence with a 30-minute wash cycle staring with an initial pH=8 from time T=0 to T=2 min, then to an increased pH=12 from T=2 to T=12 min, then to a slightly decreased pH=8 from T=12 min to T=30 min, followed by an acidic rinse at pH=4. This sequence delivers similar benefits as sequence 6 but is preferred for removal of body soils (i.e. PC132 sebum and ASTM sebum stains in Table 2).

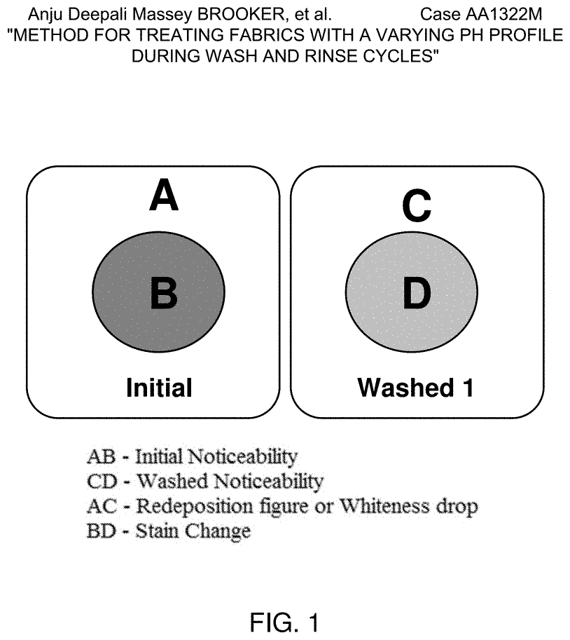

Once the wash and rinse cycles are finished, the textile swatches are removed from each of the vessels and introduced in individual drying bags in all cases. Afterwards, the textiles are dried for 45 min at low temperature in an Electrolux T3290 gas dryer. The extent of stain removal is calculated as the color difference between the stain and the textile's background before and after wash (see FIG. 1).

The initial color difference is defined as initial noticeability (ABᵢ, Equation 1), whereas the final noticeability (ADᵢ, Equation 2) refers to the color difference between the stains and the textiles' background after the wash. The Stain Removal Index (SRIᵢ) for a given stain i is calculated as described by Equation 3.

$$\begin{matrix}{AB}_{i} = \sqrt{{( {L}_{{s}_{io}} - {L}_{{b}_{o}} )}^{2} + {( {a}_{{s}_{io}} - {a}_{{b}_{o}} )}^{2} + {( {b}_{{si}_{o}} - {b}_{{b}_{o}} )}^{2}} & Equation 1 \\ {AD}_{i} = \sqrt{{( {L}_{{s}_{if}} - {L}_{{b}_{o}} )}^{2} + {( {a}_{{s}_{{i}_{f}}} - {a}_{{b}_{o}} )}^{2} + {( {b}_{{s}_{i} f} - {b}_{bo} )}^{2}} & Equation 2 \\ {SRI}_{i} ( \% ) = \frac{{IN}_{i} - {FN}_{i}}{{IN}_{i}} \cdot 100 & Equation 3\end{matrix}$$

Where Lₛ_{ᵢₒ}, aₛ_{ᵢₒ}, bₛ_{ᵢₒ} and Lₛ_{_{if}}, aₛ_{_{if}}, bₛ_{_{if}} are the initial and final color coordinates of a given stain i in the L*a*b* color space respectively and L_{b}_{ₒ}, a_{b}_{ₒ}, b_{b}_{ₒ} are the initial color coordinates of the textiles' background (L*a*b* color space).

TABLE 2

| | Seq 1 | Seq 2 | Seq 3 | Seq 4 | Seq 5 | Seq 6 | Seq 7 |
|---|---|---|---|---|---|---|---|
| Wash | pH = 8 | pH = 8 | pH = 12 | pH = 8 | pH = 8 | pH = 8 | pH = 8 |
| (30 mins) | (30 mins) | | (10 mins) | (20 mins) | (10 mins) | (20 mins) | (2 mins) |
| | | | | | pH= 12 | | pH = 12 |
| | | | | | (20 mins) | | (10 mins) |
| | | | pH = 8 | pH = 11 | | pH= 12 | pH = 8 |
| | | | (20 mins) | (10 mins) | | (10 mins) | (18 mins) |
| Rinse | pH = 8 | pH = 4 | pH = 4 | pH = 4 | pH = 4 | pH = 4 | pH = 4 |
| (15 mins) | | | | | | | |

Stain Removal Results (SRI and ΔSRI)

| | (SRI) | (ΔSRI) | (ΔSRI) | (ΔSRI) | (ΔSRI) | (ΔSRI) | (ΔSRI) |
|---|---|---|---|---|---|---|---|
| PCS132 | 39.7 | −1.8 | 7.0 | 2.8 | 3.4 | 7.4 | 12.6 |
| ASTM | 50.9 | 0.3 | 11.6 | −5.4 | 0.6 | 3.5 | 5.3 |
| Bacon | 71.3 | −7.4 | −5.2 | −4.7 | −7.7 | −2.8 | −8.8 |
| Coffee | 74.7 | 5.8 | −1.0 | 5.6 | 10.7 | 10.2 | 7.7 |
| Tea | 46.0 | 31.6 | −6.0 | 22.2 | 17.1 | 21.8 | 22.1 |
| Wine | 76.5 | 8.7 | −20.5 | 4.1 | 2.8 | 6.7 | 3.9 |
| Blood | 77.4 | 4.0 | 3.1 | 3.2 | 5.2 | 5.1 | 7.3 |
| Blueberry | 81.5 | 3.0 | −5.2 | 1.5 | −0.4 | 5.2 | 2.9 |
| Mustard | 52.1 | −8.6 | 22.4 | 12.5 | 26.5 | 25.4 | 24.9 |
| Grass | 73.7 | 1.6 | 4.3 | 3.9 | 3.3 | 6.5 | 8.5 |
| Ragu | 71.5 | 0.5 | 8.3 | 3.5 | 13.3 | 10.0 | 11.8 |
| Curry | 44.6 | 1.0 | 8.4 | 11.9 | 14.2 | 13.1 | 11.4 |
| Choc Soy | −9.0 | 17.4 | −11.8 | −2.3 | −0.2 | 0.3 | 2.8 |
| Make up | 36.6 | −5.0 | 0.4 | −1.4 | −12.7 | −0.3 | −11.7 |
| BTC | 66.4 | 3.4 | 1.3 | 3.0 | 6.4 | 5.6 | 7.5 |
| Average Stain | 56.9 | 3.6 | 1.1 | 4.0 | 5.5 | 7.9 | 7.2 |
| Removal | | | | | | | |

Sequence 7 provides the best body soil removal (i.e. PCS132 sebum and ASTM sebum stains).

### Example 2

### Use of Anionic Soil Release Polymer to Improve Whiteness Benefit

The experiment is carried out in a Miele W1714 full scale front loading washing machine. All machines are boiled out prior to use (90° C. cotton cycle) and the filters are emptied and cleaned.

Three kilograms of cotton/polycotton ballast is added to each machine (ratio of 13 cotton: 11 polycotton), along with 2 reps of single cycle whiteness swatches (consisting of swatches 15×15 cm of terry towel, knitted cotton, polycotton and polyester tagged together) and 8 reps of multicycle whiteness swatches. Eight WfK SBL2004 soil sheets are added to each load, and together the ballast, whiteness swatches and WfK soil sheets are layered evenly throughout the load.

Four runs are carried out, with the ballast and whiteness swatches being dried after each run for 30 minutes low heat in an Electrolux T3290 gas dryer. The corresponding ballast to the product is reused for each run, with the multicycle whiteness swatches being washed in every run, and two new single cycle whiteness swatches being added to each run along with 8 new WfK SBL2004 soil sheets.

Each composition is added into the drum in a small pot at the start of the wash, and the cycle is set to 40° C. cotton short (1 hr 25 minutes), with city water (8.2 US gpg).

The same inventive wash process is used for treating the whiteness swatches with either Composition B or C, i.e., the main wash is conducted at pH =8 for 2 minutes and then at an increased pH=11 for 10 minutes, followed by a slightly decreased pH=8 for the remainder of the wash (with a total wash time of 30 minutes). After two normal rinses, the final rinse is conducted at an acidic pH=4 for 15 minutes.

TABLE 3

| | | Composition | Composition |
|---|---|---|---|
| | | B | C |
| Group | Component | (ppm) | (ppm) |
| Surfactants | LAS | 298.9 | 298.9 |
| | Nonionic Surfactant | 245.9 | 245.9 |
| | (C₁₄-C₁₅ AA with average | | |
| | EO of about 7) | | |
| | C₁₂-C₁₄ AES (70% Paste) | 219.9 | 219.9 |
| Builders/ | Fatty Acids | 121.0 | 121.0 |
| Chelants | Citric Acid (50%) | 75.2 | 75.2 |
| | Citric acid | 155.6 | 155.6 |
| | Diethylene triamine | 18.2 | 18.2 |
| | penta(methyl phosphonic) | | |
| | acid (DTPMP) | | |
| Performance | Clay dispersant polymer | 24.5 | 24.5 |
| actives/ | Polyethylene glycol-Polyvinyl | 50.5 | 50.5 |
| preservatives | acetate copolymer | | |
| | TexCare ® SRA-300 | 0 | 38.5 |
| | Brightener | 3.9 | 3.9 |
| | Preservatives | 0.2 | 0.2 |
| Enzymes/ | Protease | 1.61 | 1.61 |
| stabilisers | Amylase | 0.20 | 0.20 |
| | Mannanase | 0.16 | 0.16 |
| | Pectate Lyase | 0.087 | 0.087 |
| | CaCl2 solution | 0.3 | 0.3 |
| | Na Formate (40% solution) | 8.6 | 8.6 |
| | Ethanol | 19.5 | 19.5 |
| | 1,2 Propylene glycol | 124.9 | 124.9 |
| Solvent/ | NaCS | 52.1 | 52.1 |
| neutralizer/ | Caustic | 103.6 | 103.6 |
| structurant | MEA hydrogenated castor oil | 15.1 | 15.1 |
| Antifoam | Silicone emulsion | 0.105 | 0.105 |

The whiteness swatches are measured for L*a*b* at D65 illumination, C10° observer, SCE and the W CIE index is calculated. Following is the whiteness index measured for Compositions B and C.

TABLE 4

| | Whiteness Index |
|---|---|
| Composition B | 136 |
| Composition C | 141 |

The presence of the anionic soil release polymer TexCare® SRA-300 results in a significant whiteness index increase.

### Example 3

Use of AAS/AA-Free Aqueous Wash Liquor in Combination with Varying pH Profile to Treat Fabrics

All experiments are conducted in a mid-scale high throughput equipment that runs on a Peerless Systems platform. It consists of 10 vessels of 1 L capacity with a three-blade post agitator similar to the one used by Ganguli and Eenderbug (1980) which operate in parallel. The equipment is automatized so that filling, washing, draining and rinsing of the vessels is automatically conducted by the system.

Two aqueous wash liquors with the following throw-the-wash (TTW) compositional breakdowns (in ppm) are prepared:

TABLE 5

| Component | | Formulation 1 | Formulation 2 |
|---|---|---|---|
| Type | Ingredients | (ppm) | (ppm) |
| Surfactants | Sodium lauryl sulphate | 284.18 | 0.00 |
| | Sodium | 367.94 | 367.94 |
| | dodecylbenzenesulfonate | | |
| | C14-15 Pareth-7 | 188.03 | 0.00 |
| | (Neodol 45-7) | | |
| | Lauramine oxide | 28.63 | 28.63 |
| Builders/ | Fatty acids (palm kernel) | 86.33 | 86.33 |
| Chelants | Citric acid | 108.62 | 108.62 |
| | Hydroxyethylidene | 25.00 | 25.00 |
| | diphosphonic acid | | |
| | (HEDP) | | |
| | Diethylene triamine | 25.00 | 25.00 |
| | penta(methyl | | |
| | phosphonic) acid | | |
| | (DTPMP) | | |
| Performance | Polymer Lutensit Z96 | 29.74 | 29.74 |
| actives/ | (70%) | | |
| stabilisers | Copolymer of | 43.88 | 43.88 |
| | polyethylene glycol | | |
| | (PEG) and polyvinyl | | |
| | acetate (PvAc) | | |

The aqueous wash liquor of Formulation 1 (containing AAS and AS surfactants in addition to LAS) is used to treat fabrics by using a conventional fabric treatment method with pH profile 1. The aqueous wash liquor of Formulation 2 (contains only LAS without AAS and AS surfactants) is used to treat fabrics by using both the conventional fabric treatment method with pH profile 1, and by using an inventive fabric treatment method with pH profile 2, as follows:

TABLE 6

| Step | pH profile 1 | pH profile 2 |
|---|---|---|
| Wash | T = 0 − T = 30 min; | T = 0 min − T = 2 min; pH = 8 |
| | pH = 8 | T = 2 min − T = 12 min; pH = 12 |
| | | T = 12 min − T = 30 min; pH = 8 |
| Rinse | T = 0 − T = 15 min; | T = 0 min − T = 15 min; pH = 4 |
| | pH = 8 | |

Following are the specific steps of the fabric treatment methods using the aqueous wash liquors of Formulations 1 and 2, respectively, which are essentially the same except for the different pH profiles used during the wash and rinse cycles:

TABLE 7

| | | Agitation | |
|---|---|---|---|
| Steps | Time (s) | (degree/s) | Description |
| Cleaning | 0-120 | 1800 | Addition and mixing of 0.25 L of |
| | | | city water at the target temperature |
| | | | (30 ° C) to clean the vessels. |
| Draining | — | — | Draining of water from cleaning |
| | | | step. |
| Dilution | 0-120 | 1800 | Addition of 0.8 L of city water at |
| (T = 240 s) | | | 30° C and mixing for 2 min. |
| | 120-240 | 1800 | Addition of ballast (50 g of 5 cm × |
| | | | 5 cm knitted cotton swatches) and |
| | | | test items containing the stains |
| | | | (10 g of 7 cm 7 cm knitted cotton |
| | | | swatches) remaining in contact |
| | | | with the water for 2 minutes. |
| Wash | 0-1800 | 1800 | At time T = 0 s of wash step, |
| (T = 1800 s) | | | addition of 0.2 L at 30° C of water |
| | | | containing the pre-dissolved |
| | | | detergent formulation (see Table |
| | | | 5). The pH profile in main wash is |
| | | | specified in Table 6. Washing of |
| | | | textiles for 30 min at 30° C. |
| Draining | — | — | Draining of water from washing |
| | | | step. |
| Rinse | 0-900 | 1800 | At T = 0 s of the rinsing step, |
| | | | addition of 1 L of city water at |
| | | | 30° C. Rinsing of textiles occurs |
| | | | for 15 min under constant agitation |
| | | | of 1800 deg/s. The pH profile of |
| | | | the rinsing step is specified in |
| | | | Table 6. |

Following are the stain removal results by using the aqueous wash liquors of Formulations 1 and 2, while using different pH profiles during the wash and dry cycles. The stain removal results are measured by using a method similar to that described in Example 1:

TABLE 8

| | Wash Liquors and pH Profiles | | |
|---|---|---|---|
| | Formulation 1 | Formulation 2 | Formulation 2 |
| | (AAS + AA) | (No AAS/AA) | (No AAS/AA) |
| | (Profile 1) | (Profile 1) | (Profile 2) |
| (Types of Stains) | SRI | ΔSRI | ΔSRI |
| Beef | 68.04 | −19.33 | −6.95 |
| Butter | 71.51 | −13.29 | 0.57 |
| PCS132 | 28.45 | −10.65 | 10.44 |
| ASTM | 38.37 | −22.69 | −4.03 |
| Bacon | 81.20 | −13.18 | −8.00 |
| Coffee | 66.46 | −2.13 | 9.75 |
| Tea | 41.01 | −5.11 | 13.33 |
| Wine | 65.30 | −5.59 | 3.89 |
| Blood | 64.88 | −8.95 | 9.11 |
| Blueberry | 77.48 | −3.26 | 0.22 |
| Mustard | 56.38 | −6.11 | 20.82 |
| Grass | 48.89 | −12.44 | −1.27 |
| Ragu | 48.54 | −0.38 | 12.92 |
| Curry | 38.42 | 0.15 | 21.12 |
| rice Starch | 28.73 | −3.18 | 6.79 |
| Choc Soy | −26.54 | −1.09 | 20.46 |
| Carrot | 74.96 | −4.44 | 5.59 |
| Make up | 41.74 | −9.95 | 13.14 |
| BTC | 59.81 | −4.80 | 10.40 |
| Average | 51.24 | −7.71 | 7.28 |

The above SRI and ΔSRI data demonstrate that removal of AAS and AA surfactants from the aqueous wash liquor of Formulation 1 (while the AAS/AS-free aqueous wash liquor of Formulation 2), while still using the conventional fabric treatment method with the pH profile 1, results in visible reduction of stain removal benefits. In contrast, the same AAS/AA-free aqueous wash liquor of Formulation 2, when used in the inventive fabric treatment method with the pH profile 2, can achieve stain removal results that are mostly comparable with (in average even slightly better than) those achieve by using the AAS/AA-containing aqueous wash liquor of Formulation 1.

TABLE 9

| | Wash Liquors and pH Profiles | |
|---|---|---|
| | Formulation 1 | Formulation 2 |
| | (AAS + AA) | (No AAS/AA) |
| | (Profile 2) | (Profile 2) |
| (Types of Stains) | SRI | ΔSRI |
| Beef | 60.0 | 1.1 |
| Butter | 74.8 | −2.7 |
| PCS132 | 52.3 | −13.4 |
| ASTM | 56.2 | −21.9 |
| Bacon | 62.5 | 10.7 |
| Coffee | 82.4 | −6.2 |
| Tea | 68.1 | −13.8 |
| Wine | 80.4 | −11.2 |
| Blood | 84.7 | −10.7 |
| Blueberry | 84.4 | −6.7 |
| Mustard | 77.0 | 0.2 |
| Grass | 82.2 | −34.6 |
| Ragu | 83.3 | −21.8 |
| Curry | 56.0 | 3.5 |
| rice Starch | 46.0 | −10.5 |
| Choc Soy | −6.2 | 0.1 |
| Carrot | 81.4 | −0.8 |
| Make up | 24.9 | 30.0 |
| BTC | 73.9 | −3.7 |
| Average | 64.4 | −5.9 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating fabrics, comprising the steps of:
a) Contacting fabrics with an aqueous wash liquor containing at least one detersive surfactant, wherein said aqueous wash liquor is characterized by a first pH ranging from 7.0 to 9.0;
b) Increasing the pH of said aqueous wash liquor to a second pH ranging from 10.0 to 13.0, while allowing the fabrics to continue contacting with such aqueous wash liquor for a duration ranging from 5 minutes to 30 minutes; and
c) Contacting the fabrics with an aqueous rinse liquor that is characterized by a third pH ranging from 3.0 to 6.0,
and wherein the method comprises a further a step (b 1) of decreasing the pH of said aqueous wash liquor back to a fourth pH ranging from 7.0 to 9.0 after step (b) and before step (c), wherein in said step (b1) the fabrics are contacted with said aqueous wash liquor for a duration ranging from 1 minute to 60 minutes.

2. The method of claim 1, wherein in step (b) said second pH ranges from 10.5 to 12.5, preferably from 11.0 to 12.0; and/or wherein said duration ranges from 8 minutes to 25 minutes, preferably from 10 to 20 minutes.

3. The method of claim 1, wherein in step (b1) the fabrics are contacted with said aqueous wash liquor for a duration ranging from 5 minutes to 40 minutes.

4. The method according to claim 1, wherein in step (a) the fabrics are contacted with said aqueous wash liquor for a duration ranging from 1 minute to 30 minutes, preferably from 2 minutes to 20 minutes.

5. The method according to claim 1, wherein in step (c) the fabrics are contacted with said aqueous rinse liquor for a duration ranging from 1 minute to 30 minutes, preferably from 5 minutes to 20 minutes, more preferably from 10 minutes to 15 minutes.

6. The method according to claim 1, wherein said aqueous wash liquor further comprises an anionic soil release polymer, and wherein said anionic soil release polymer is preferably a terephthalate polymer, more preferably an anionic polyester of propylene terephthalate.

7. The method according to claim 1, wherein said aqueous wash liquor is essentially free of C₁₀-C₂₀ linear or branched alkylalkoxylated sulfates (AAS) and C₁₀-C₂₀ linear or branched alkylalkoxylated alcohols (AA); and wherein preferably said aqueous wash liquor is essentially free of alkylalkoxylated surfactants.

8. The method according to claim 1, wherein said aqueous wash liquor comprises one or more C₁₀-C₂₀ linear alkyl benzene sulphonates (LAS) or alkyl sulfates (AS) as the main surfactant(s).

9. The method according to claim 7, wherein said aqueous wash liquor is essentially free of C₁₀-C₂₀ linear or branched alkylalkoxylated sulfates (AAS) and C₁₀-C₂₀ linear or branched alkylalkoxylated alcohols (AA); and wherein preferably said aqueous wash liquor is essentially free of alkylalkoxylated surfactants, and wherein said aqueous wash liquor comprises one or more C₁₀-C₂₀ linear alkyl benzene sulphonates (LAS) or alkyl sulfates (AS) as the main surfactant(s).

10. The method according to claim 1, wherein during step (c) 5-chloro-2-(4-chlorophenoxy) phenol is dosed into the aqueous rinse liquor.
